(19) United States
(12) Patent Application Publication
(10) Pub. No.: US 2025/0148475 A1
(43) Pub. Date: May 8, 2025

(54) MONETARY DELIVERY SYSTEM

(71) Applicant: Sameeksha Mehrotra, Frisco, TX (US)

(72) Inventor: Sameeksha Mehrotra, Frisco, TX (US)

(21) Appl. No.: 18/441,171

(22) Filed: Feb. 14, 2024

Related U.S. Application Data
(63) Continuation-in-part of application No. 17/164,451, filed on Feb. 1, 2021, now abandoned.
(60) Provisional application No. 62/981,115, filed on Feb. 25, 2020.

(51) Int. Cl. G06Q 20/42; G06Q 20/38; G06Q 20/40

(52) U.S. Cl. CPC G06Q 20/42; G06Q 20/381; G06Q 20/4014

(57) ABSTRACT

A system using a delivery process for requesting and receiving money. The delivery process includes authentication layers which allows a user or service provider to set up and login to the system. If too many unsuccessful attempts are made, a time out or account suspension may occur. A client may request transactions as well as request information such as exchange rates. Money may be requested by the receiver or the sender. The system performs the monetary transaction and the recording of the transaction.

### CROSS-REFERENCE TO RELATED APPLICATIONS

This application is a Utility patent application claiming priority to U.S. patent application Ser. No. 17/164,451, filed Feb. 1, 2021, which claims priority to U.S. Provisional Patent Application 62/981,115, filed on Feb. 25, 2020, both of which are incorporated by reference herein in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1. Field of the Invention

The invention relates in general to the field of finance and more specifically to a delivery process for sending and receiving monetary assets.

### 2. Description of Related Art

Currently the state of the art includes Embodiments of the invention described in this specification relate generally to money delivery systems, and more particularly, to a non-financial monetary delivery system.

Many people would like to transfer money to friends or family in a different country, however, many of the intended recipients of such transferred money cannot afford to go to a financial institution to collect the money.

Current money delivery infrastructure expects person to either travel to financial institution location to collect money or own an account in financial institution.

Therefore, what is needed is a way to eliminate the need for an individual to own an account with financial institution in order to deliver and receive money on demand at doorstep in respective foreign currency.

### SUMMARY OF THE INVENTION

Bearing in mind the problems and deficiencies of the prior art, it is therefore an object of the present invention to provide a delivery process for sending and receiving monetary assets.

It is another object of the present invention to provide a system which includes software for the delivery process for sending and receiving monetary assets.

Still other objects and advantages of the invention will in part be obvious and will in part be apparent from the specification.

The above and other objects, which will be apparent to those skilled in the art, are achieved in the present invention which is directed to a computer readable medium comprising instructions which, when executed by a processor, cause the computer readable medium to carry out steps of a delivery process for requesting and receiving money. The steps for the delivery process include a user accessing a login and signup screen and the system creating a subscriber profile with a subscriber type. If the subscriber profile is not complete, sending at least one reminder until the subscriber completes the subscriber profile. If the subscriber type is a service provider, capturing the subscriber consent to execute a background check. If the background check is passed from checking agency, updating the status of subscriber profile with a background check status; and returning the user to the login and signup screen. If the background check is not passed from the checking agency, declining subscription to the user and send an email to the user. If the subscriber type is not a service provider and if the user intends to initiate a transaction and if the user want to send money, the money sender subscriber initiate this transaction. The delivery process includes choosing a money receiver subscriber mapped to a money sender subscriber. If the money receiver subscriber is not found, creating a money receiver subscriber profile. The delivery process includes initiating a send money transaction and depositing the money sent in a system administrator bank account. The delivery process includes the money sender and money receiver receiving a system generated transaction code and performing a broadcast transaction. The delivery process includes the money receiver subscriber initiating a transaction, linking the money sender subscriber to the money receiver subscriber, initiating a request for a money transaction 38 and routing the money transaction to a designated money sender subscriber. The delivery process includes the money sender subscriber reviewing the transaction and, if the money transfer is approved, process the send money transaction. If the money transfer is not approved, declining the money transaction and switching the money transaction status to declined and skipping to the end program step. The delivery process includes broadcasting the transaction to service providers who covers the money receiver zip code and, if the service provider accepts transaction the service provider subscriber accepts the transaction, linking money transaction to service provider who accepted transaction and marking the transaction as reserved. The delivery process includes removing the money transaction from the broadcast, the service provider delivering money to money receiver, the service provider keying in transaction code shared by money receiver subscriber, a system administrator validating the transaction code and, if the code is valid, transferring money to service provider account and marking the transaction as completed and ending program, and if the code is not valid, declining the transfer to service provider and increment number of attempts by 1, and if the number of attempts is less than 3, then returning to checking if the code is valid, and if the number of attempts is not less than 3, GOTO Broadcast transaction to service providers who covers the money receiver zip code. The delivery process steps include ending the program.

A non-financial monetary delivery system and a non-financial monetary delivery process are disclosed which eliminate the need for an individual to own an account with a financial institution in order to request, have delivered, and receive money on demand at a location of the individual (virtual doorstep) in a respective foreign currency.

The preceding summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a banking information module of a non-financial monetary delivery system in some embodiments;

FIG. 2 illustrates a subscriber information module of the non-financial monetary delivery system in some embodiments;

FIG. 3 illustrates a money transaction module of the non-financial monetary delivery system in some embodiments;

FIG. 4 illustrates a service provider geospatial locator module (“geo-locator module”) of the non-financial monetary delivery system in some embodiments;

FIG. 5 illustrates a money-in module of the non-financial monetary delivery system in some embodiments;

FIG. 6 illustrates a money-out module of the non-financial monetary delivery system in some embodiments;

FIG. 7 illustrates a subscriber and service provider mapping terminal module of the non-financial monetary delivery system in some embodiments;

FIG. 8 illustrates a subscriber type categorization module that specifies requirements for each type of subscriber in some embodiments;

FIG. 9 illustrates a money-in and money-out relationship diagram of the non-financial monetary delivery system in some embodiments;

FIG. 10 illustrates a geo-locator and mapping terminal relationship diagram of the non-financial monetary delivery system in some embodiments;

FIG. 11 illustrates a non-financial monetary delivery process in some embodiments;

FIG. 12 is a continuation of the non-financial monetary delivery process shown in FIG. 11;

FIG. 13 illustrates a background check module of the non-financial monetary delivery system in some embodiments;

FIG. 14 illustrates a subscriber and background check relationship diagram of the non-financial monetary delivery system in some embodiments;

FIG. 15 illustrates a global banking module of the non-financial monetary delivery system in some embodiments;

FIG. 16 illustrates a global banking and money-in relationship diagram of the non-financial monetary delivery system in some embodiments;

FIG. 17 illustrates a global banking and money-out relationship diagram of the non-financial monetary delivery system in some embodiments;

FIG. 18 illustrates an electronic system with which some embodiments of the invention are implemented;

FIG. 19 is a diagram showing another aspect of the delivery system according to the present invention;

FIG. 20 is a diagram showing one aspect of the delivery system according to the present invention;

FIGS. 21A-C show the steps of the delivery process for requesting and receiving money; and

FIG. 22 shows a diagram of a system module having users perform a specific request.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Some embodiments of the invention include non-financial monetary delivery system that eliminates the need for an individual to own an account with a financial institution in order to request, have delivered, and receive money on demand at a location of the individual (virtual doorstep) in a respective foreign currency, and some embodiments include a non-financial monetary deliver process for the same. In some embodiments, the non-financial monetary delivery system includes a banking information module, a subscriber information module, a money transaction module, money-in module, a money-out module, a mapping terminal module, a geo-locator module, and a subscriber type categorization module which individually and collectively support money transfer transactions between a money sender subscriber and a money receiver subscriber by way of a service provider subscriber.

In some embodiments, the non-financial monetary delivery process includes several steps for completing a money transfer transaction between a money sender subscriber and a money receiver subscriber by way of a service provider subscriber, whereby (i) the money receiver subscriber requests money via the money-in module, (ii) the mapping terminal module is used to determine mappings between the money receiver subscriber, the money sender subscriber, and a list of service provider subscribers which can be routed through a global banking account upon funding of an amount of money by the money sender subscriber, (iii) delegating a money out request from the money sender subscriber to the list of service provider subscribers, (iv) accepting the money out request by a particular service provider subscriber in the list of service provider subscribers, (v) delivering the money to the money receiver subscriber by the particular service provider subscriber, (vi) receiving a money-in code for the particular service provider subscriber to enter upon delivery of the money to the money receiver subscriber, and (vii) transferring the amount of money, which covers the money delivered and an associated service provider subscriber fee, to the particular service provider subscriber from the global banking account as funded by the money sender subscriber for delivery of the money to the money receiver subscriber.

Embodiments of the non-financial monetary delivery system and the non-financial monetary deliver process described in this specification solve the problems noted above by implementation of software that runs on a computing device, such as implementation of an app (e.g., a mobile app that runs on a smartphone) and/or website cloud service, in which subscribers (money sender subscribers) of the app/website can send money to family (money receiver subscribers) in a different country by generating a code with intent to send money and giving the code to a target family member (money receiver subscriber), followed by broadcasting the intent of transfer to service provider subscribers in the target country area. The target country service provider subscriber who volunteers to go to the home (or other specified location) of and give the money to the targeted family member (money receiver subscriber) will get the code and enter it (e.g., into the mobile app) to get money transferred from the source money sender subscriber's account or from a global banking account funded by the money sender subscriber, thereby making transferring and delivering money to family members in foreign countries easier since there is no need for the money receiver subscriber (e.g., family members or others) to have an individual bank account. This also makes money readily available for family members in foreign countries who may not have resources to accept money in a bank (without a bank account) or travel to a remote location and collect money from the receiving financial institution.

In addition, some embodiments of the non-financial monetary delivery system and the non-financial monetary deliver process improve upon the currently existing options which operate based on the fundamental assumption that everyone in foreign country has account with a financial institution, which is not true for all countries which are still in a developing phase (e.g., countries in Africa or India). However, the non-financial monetary delivery system and the non-financial monetary deliver process remedy this problem by eliminating the need for an individual to own an account with a financial institution, by delivering money to them on demand at their doorstep in the respective foreign currency.

The non-financial monetary delivery system and the non-financial monetary delivery process of the present disclosure may be comprised of the following elements and carry out the following steps.

1. Subscribers include money delivery drivers/individuals (service provider subscribers in the app), source of money transfer individuals/entities (money sender subscribers in the app), and target money transfer individuals/families for delivery of the money (money receiver subscribers in the app).
2. Source (money sender) and target (money receiver) are mapped m a mapping table, via a mapping terminal module, at the time of subscription in the app.
3. Money delivery drivers subscribe in the app with bank account details to become service provider subscribers.
4. When target money receiver subscriber initiates a request for money, a money-in request is transmitted by a money-in module to go immediately and directly to the mapped source money sender subscriber automatically.
5. The source money sender subscriber accepts the money-in request and gets a system generated code that it shares with the target money receiver subscriber to (subsequently) share only with a service provider subscriber (e.g., delivery driver) who delivers the money to the location of the target money receiver subscriber.
6. The source money sender subscriber then uses geo-search by geography of the target money receiver subscriber to broadcast the intent to transfer the money to all service provider subscriber delivery drivers in that area. The service provider subscriber who accepts and delivers the money to the target money receiver subscriber (e.g., at the doorstep of the target or other specified location) then gets the code from the target money receiver subscriber.
7. The service provider subscriber who delivered the money to the target money receiver subscriber inputs, enters, or confirms the code to the source money sender subscriber (via the mobile app) and then the source money sender subscriber transfers the money to the bank account of the service provider subscriber. Alternatively, the source money sender subscriber provides the money to a global banking account in advance of the service provider subscriber delivering the money to the target money receiver subscriber, and when the service provider subscriber enters the code after delivery of the money to the target money receiver subscriber, the global banking account triggers the automatic release and transfer of the money to the bank account of the service provider subscriber.
8. A money transaction record is created in the database with the code and amount of money transferred between the source money sender subscriber, the target money receiver subscriber, and the service provider subscriber along with other details and a date and time stamp.

The non-financial monetary delivery system and the non-financial monetary deliver process of the present disclosure uses the subscriber module to create the different types of subscribers (e.g., money sender subscriber, money receiver subscriber, service provider subscriber). However, it is possible that a subscriber can be two or more different types of subscribers with respect to different mappings related to different subscribers. While both money sender subscribers and service provider subscribers need to have bank account details, payments and completion of transactions is always dependent upon money transfers from funded accounts. Also, the typical working use case involves the source and the target having many to many (M-M) mappings with each other in the database.

To make the non-financial monetary delivery system and carry out the non-financial monetary deliver process, application development may be involved to store various devices using a programming language or framework, such as the JavaScript framework. To use the non-financial monetary delivery system and the non-financial monetary deliver process, a person may download the app from an app store and subscribe to it free or cost. Additionally, the non-financial monetary delivery system and the non-financial monetary deliver process eventually can support card chips for subscribers which can be linked to their bank accounts for easy transfer of money between source and money delivery driver.

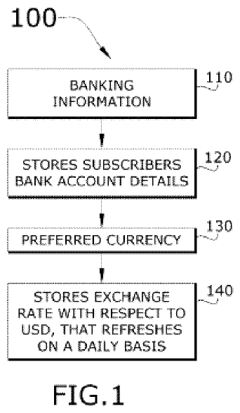

Referring now to the drawings FIG. 1-23, and more particularly to FIG. 1, there is shown an example which illustrates a banking information module 100 of a non-financial monetary delivery system in some embodiments. As shown in this figure, the banking information module 100 includes banking information 110 of subscribers, including money sending subscribers and service provider subscribers. Banking information is not required of money receiver subscribers. The banking information module 100 stores subscriber bank account details 120. In some embodiments, this includes the banking information 110 and a preferred currency 130. The banking information module 100 of some embodiments also stores the exchange rate 140 with respect to a particular currency, namely, the United States dollar, and refreshes the stored exchange rate on a daily basis. A person skilled in the relevant art would appreciate that another currency could be used for the exchange rate of 140.

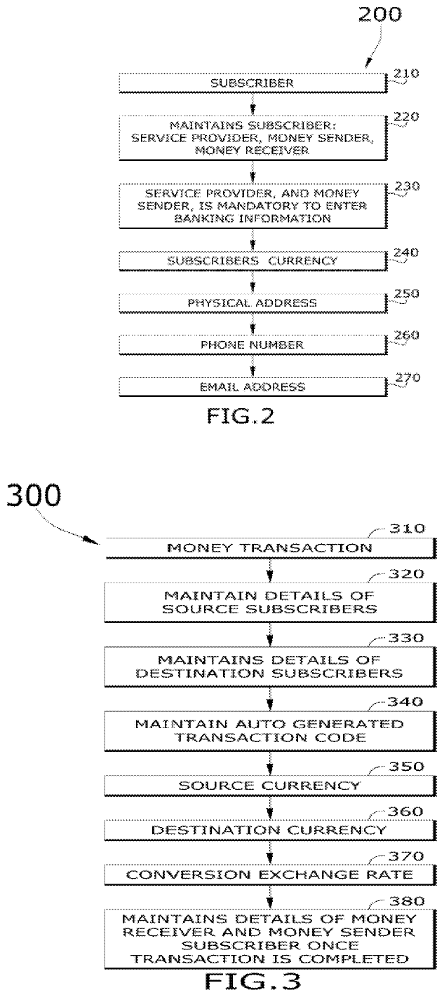

Turning to another example, FIG. 2 conceptually illustrates a subscriber information module 200 of the non-financial monetary delivery system in some embodiments. The subscriber information module 200 is used in the non-financial monetary delivery system to store details of a subscriber (at 210). The subscriber information module 200 maintains each type of subscriber (at 220), which includes money sender subscribers, money receiver subscribers, and service provider subscribers. For service providers and money senders, the stored details must include banking information (at 230), while other details for all subscribers are stored, including subscriber's currency (at 240), physical address of subscriber (at 250), phone number of subscriber (at 260), and email address of subscriber (at 270).

Now referring to another example, FIG. 3 conceptually illustrates a money transaction module 300 of the non-financial monetary delivery system in some embodiments. The money transaction module 300 is used by the non-financial monetary delivery system to store money transaction details of source, destination, and service provider subscriber (at 310). Therefore, the money transaction module 300 maintains details of the source subscribers (at 320), maintains details of the destination subscribers (at 330), and maintains auto-generated transaction code (at 340). The money transaction module 300 also maintains source currency (at 350), destination currency (at 360), conversion exchange rate (at 370), and details of money receiver and money sender subscribers once the transaction is complete (at 380).

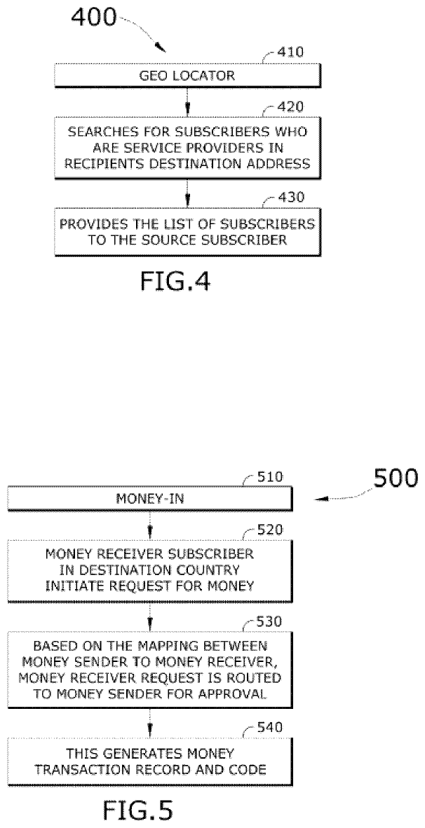

By way of another example, FIG. 4 conceptually illustrates a service provider geospatial locator (“geo-locator”) module 400 of the non-financial monetary delivery system in some embodiments. The geo-locator module 400 is a transactional module that is used by the non-financial monetary delivery system to compute a list of suggested service providers in or near an area associated with the money receiver subscriber's address (at 410). Therefore, the geo-locator module 400 searches for subscribers who are service providers in or around the recipient's destination address (at 420) and provides the list of subscribers to the source subscriber (at 430).

Turning to another example, FIG. 5 conceptually illustrates a money-m module 500 of the non-financial monetary delivery system in some embodiments. The money-in module 500 is used by the non-financial monetary delivery system to map out a routing for sending money from the money sender to the money receiver (at 510). Therefore, the money-in module 500 is triggered when a money receiver subscriber in a country (destination country) initiates a request for money (at 520) and, based on a mapping between the money sender and the money receiver, routes the money receiver request to the money sender for approval (at 530), which results in generation of a money transaction record and code (at 540).

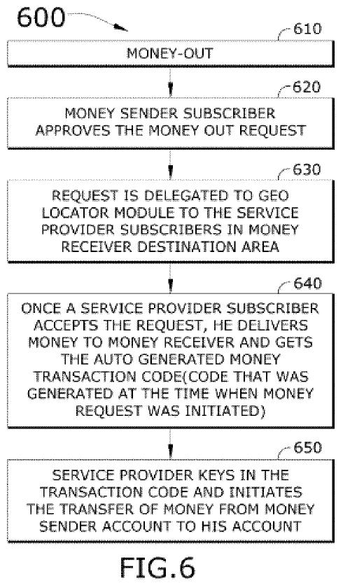

By contrast to the money-in module 500 described above, FIG. 6 conceptually illustrates a money-out module 600 of the non-financial monetary delivery system in some embodiments. The money-out module 600 is used by the non-financial monetary delivery system to empower the money sender subscriber in moving the money transfer forward (at 610). Therefore, the money-out module 600 waits for the money sender subscriber to approve the money out request (at 620), at which time the geo-locator module 400 is triggered to identify service provider subscribers who would be appropriate, and then delegates the money out request to the identified service provider subscribers who are in or nearby the money receiver's destination area (at 630). Once the service provider subscriber accepts the money out request, money delivery occurs, whereby the service provider subscriber delivers the money to the money receivers and then gets the auto-generated money transaction code (i.e., the code that is generated at the time when the money request is initiated at 540), which the service provider subscriber will subsequently use to complete the transaction and transfer the money into his/her account (at 640). For money delivery to complete, therefore, the service provider subscriber inputs the transaction code and initiates a transfer of the money from the money sender account to the service provider account (at 650).

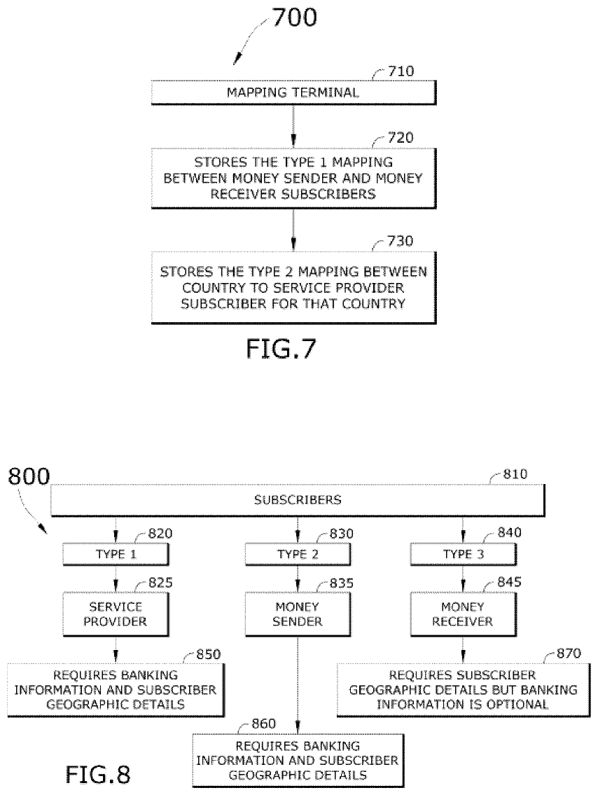

Moving to another example, FIG. 7 conceptually illustrates a subscriber and service provider mapping terminal module 700 of the non-financial monetary delivery system in some embodiments. The subscriber and service provider mapping terminal module 700 is used by the non-financial monetary delivery system to store type 1 and type 2 mappings, which can then be used to route the request every time it is subsequently initiated (at 710). Specifically, the subscriber and service provider mapping terminal module 700 stores the type 1 mapping between the money sender and the money receiver subscribers (at 720) and stores the type 2 mapping between the country and service provider subscribers in that country (at 730).

While the subscriber information module 200, described above by reference to FIG. 2, demonstrates a manner of storing details of the money sender subscribers, the money receiver subscribers, and the service provider subscribers in the non-financial monetary delivery system, FIG. 8 conceptually illustrates a subscriber type categorization module 800 of the non-financial monetary delivery system. The subscriber type categorization module 800 is used to specify requirements for each type of subscriber (at 810). As shown in this figure, the type 1 subscriber (at 820) is the service provider subscriber (at 825), the type 2 subscriber (at 830) is the money sender subscriber (at 835), and the type 3 subscriber (at 840) is the money receiver subscriber (at 845). The requirements for each type of subscriber includes a requirement for banking information and subscriber geographic details (at 850) for type 1 service provider subscribers, a requirement for banking information and subscriber geographic details (at 860) for type 2 money sender subscribers, and a requirement for subscriber geographic details (at 870) for type 3 money receiver subscribers (but banking information for type 3 money receiver subscribers is optional).

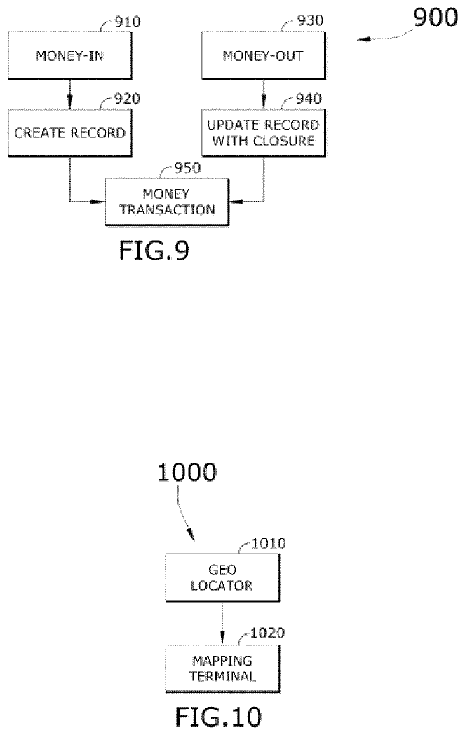

While the money transaction module 300, described above by reference to FIG. 3, the money-in module 500, described above by reference to FIG. 5, and the money-out module 600, described above by reference to FIG. 6, demonstrate the isolated elements in which a money transfer can occur via the non-financial monetary delivery system, FIG. 9 conceptually illustrates a money-in and money-out relationship diagram 900 that ties the isolated elements together within the non-financial monetary delivery system in some embodiments. As shown in this figure, the requested money-in (at 910) triggers creation of a record (at 920), while the money-out (at 930) triggers an update of the record with closure (at 940) based on the money transaction (at 950) that ties them together.

In another example, FIG. 10 conceptually illustrates a geo-locator and mapping terminal relationship diagram 1000 of the non-financial monetary delivery system in some embodiments. As shown in this figure, the geo-locator 1010 has a direct relationship with the mapping terminal 1020. As such, the use of the geo-locator module 400, described above by reference to FIG. 4, would be resolved in direction relation to the mapping terminal module 700, described above by reference to FIG. 7.

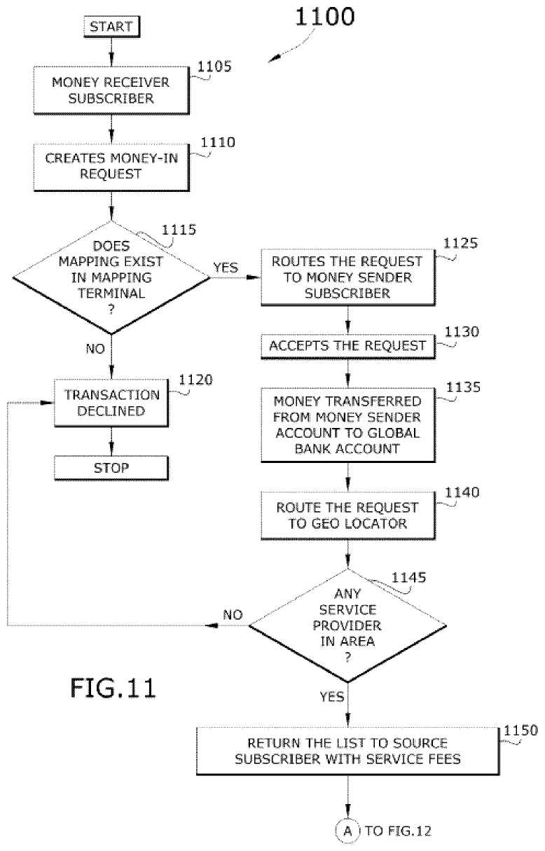

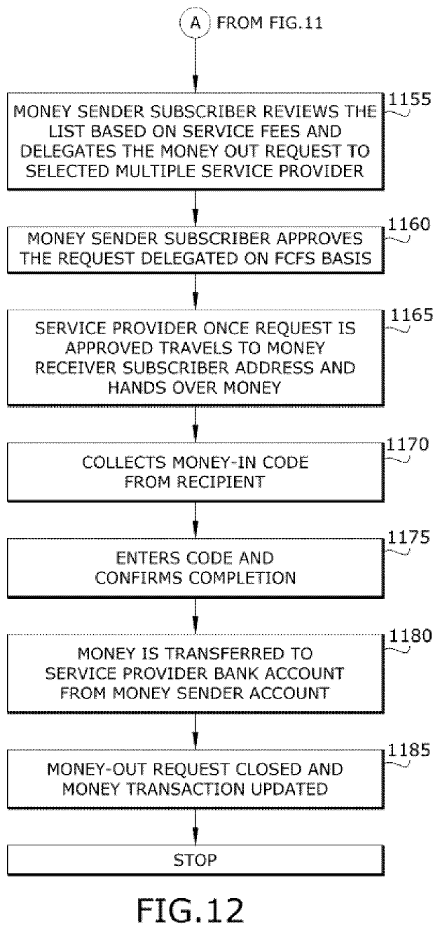

By way of example, FIGS. 11 and 12 conceptually illustrates a non-financial monetary delivery process 1100 in some embodiments. As shown in this figure, the non-financial monetary delivery process 1100 is started by a money receiver subscriber (at 1105) who creates a money-in request (at 1110). The non-financial monetary delivery process 1100 then determines (at 1115) whether a mapping exists to a money sender in the mapping terminal for the money receiver subscriber's money-in request. The mapping terminal can create the mapping when a money sender is available to accept the money-in request, otherwise the transaction would be denied. Thus, when no mapping exists in the mapping terminal, the non-financial monetary delivery process 1100 declines the transaction (at 1120) and the non-financial monetary delivery process 1100 ends.

On the other hand, when a mapping exists in the mapping terminal, the non-financial monetary delivery process 1100 routes the money-in request to the money sender subscriber (at 1125). Then, when the money sender subscriber accepts the money-in request (at 1130), the non-financial monetary delivery process 1100 proceeds to transfer the money from the money sender bank account to a global bank account (at 1135).

Next, the non-financial monetary delivery process 1100 routes the request to the geo-locator module (at 1140) which determines (at 1145) whether there is any service provider in the area in and around the destination address of the money receiver. For example, if there is no service provider subscriber in the area of the money receiver, then no mapping would exist and the transfer may not be completed. On the other hand, when a service provider subscriber exists in the area, then a mapping between the money sender and the service provider can be created with bank details of each, or, in the case where the money receiver is making a subsequent money-in request, the money sender and the service provider may already have been saved persistently by the mapping terminal. Thus, when no service provider subscriber exists within or around the area of the destination address of the money receiver, then the transaction is declined (at 1120) and the non-financial monetary delivery process 1100 ends.

On the other hand, when a service provider subscriber does exist in or around the area of the money receiver, then the non-financial monetary delivery process 1100 returns the list to the source subscriber with service fees (at 1150).

Turning now to FIG. 12, which provides a continuation of the non-financial monetary delivery process 1100, after the list is returned to the source subscriber with service fees (at 1150), the non-financial monetary delivery process 1100 proceeds to the next step at which the money sender subscriber reviews the list based on the service fees and delegates the money-out request to the selected multiple service providers (at 1155). Then the money sender subscriber approves the list and request to be delegated on a first-come, first-served basis (at 1160), meaning that the first service provider subscriber to accept the money-out request will win (if approved) from among any/all service provider subscribers in the list of multiple service providers selected by the money sender subscriber.

Next, after the request 1s approved for the first money sender, the non-financial monetary delivery process 1100 proceeds to the next step during which the first service provider subscriber travels to the money receiver subscriber's address (destination address) and delivers or hands over the money (at 1165). At the next step of the non-financial monetary delivery process 1100, the first service provider subscriber collects the money-in code from the recipient (at 1170), and then enters/inputs the code and confirms completion (at 1175). The non-financial monetary delivery process 1100 then proceeds to a step in which the money from the money sender is transferred to the first service provider subscriber's bank account from the global bank account (at 1180). Then the money-out request is closed and the money transaction is updated (at 1185), after which the non-financial monetary delivery process 1100 ends.

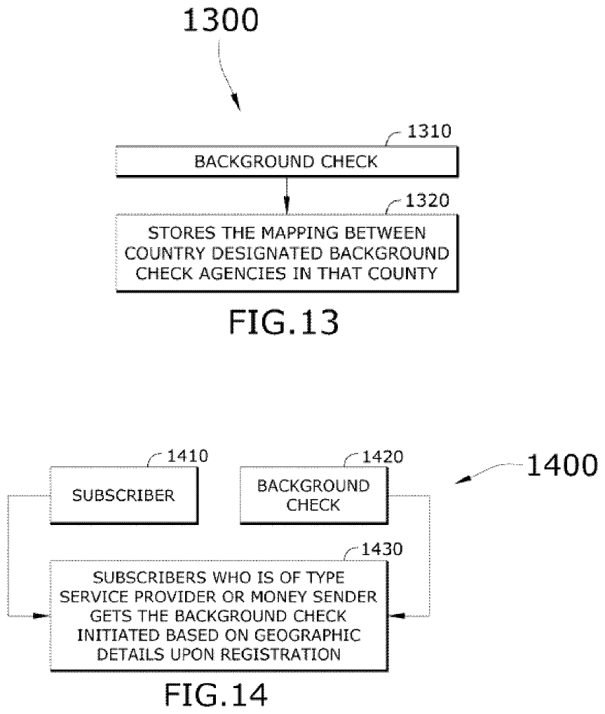

Now turning to another example, FIG. 13 conceptually illustrates a background check module 1300 of the non-financial monetary delivery system in some embodiments. In some embodiments, the background check module 1300 is used by the non-financial monetary deliver system to store information about background check agencies to execute background checks in connection with service provider subscribers (at 1310), which may be utilized to eliminate any anti-social entities or individuals from using the non-financial monetary delivery system non-financial monetary delivery system and/or the associated mobile app. As such, the background check module 1300 stores the mapping between country and designated background check agencies in that country (at 1320). In this way, the background check module 1300 provides a way for both money sender subscribers and money receiver subscribers to confirm that the non-financial monetary delivery system (and related application) is not used by criminals or anti-social, dangerous entities or parties, etc.

Now turning to another example, FIG. 14 conceptually illustrates a subscriber and background check relationship diagram 1400 of the non-financial monetary delivery system in some embodiments. The subscriber and background check relationship diagram 1400 links the subscriber (at 1410) and the background check (at 1420) in a relationship that requires subscribers who are service providers or money senders get a background check initiated based on the geographic details and upon registration (at 1430) in the non-financial monetary delivery system.

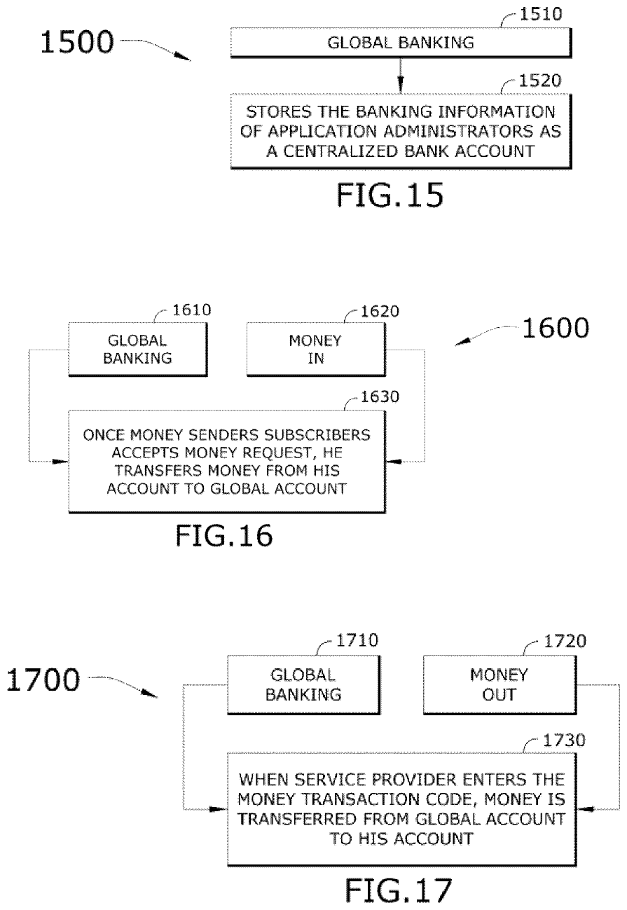

Now, FIG. 15 conceptually illustrates a global banking module 1500 of the non-financial monetary delivery system in some embodiments. The global banking module 1500 is used by the non-financial monetary delivery system to store the banking information of administrator(s) for centralized money on demand of service provider, as a centralized banking juncture to store money received from the money sender (intended for delivery to money receiver), and thereby prevent any potential of fraud to service provider subscriber (at 1510). Therefore, the global banking module 1500 stores the banking information of the application administrators as a centralized bank account (at 1520) used for successful execution of money transaction(s) and to prevent fraudulent activities in relation to the parties using the non-financial monetary delivery system.

In another example, FIG. 16 conceptually illustrates a global banking and money-in relationship diagram 1600 of the non-financial monetary delivery system in some embodiments. The global banking and money-in relationship diagram 1600 links global banking (at 1610) and money-in (at 1620) in a relationship in which the non-financial monetary delivery system ensures that once money sender subscribers accept money requests, the transfers of money from the money sender subscriber occurs from its bank account to the global banking account (at 1630).

Similarly, FIG. 17 conceptually illustrates a global banking and money-out relationship diagram 1700 of the non-financial monetary delivery system in some embodiments. The global banking and money-out relationship diagram 1700 links global banking (at 1710) and money-out (at 1720) in a relationship in which the non-financial monetary delivery system ensures that when a service provider subscriber enters or inputs the money transaction code (after traveling to the money receiver and handing the money over to the money receiver), that the money is actually transferred from the global banking account (the one in which the money sender subscriber deposited the funds) to the bank account of the service provider subscriber (at 1730).

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the terms “software”, “module”, “application”, “app”, and “mobile app” (referred to below as “software”) are meant to include firmware residing in read-only memory or applications stored in magnetic storage, which can be read into memory for processing by a processor, such as the processor of a mobile computing device or a mobile communication device, such as a smartphone, a hand-held computing device, or a tablet computing device (referred to simply as a “mobile device”), or the processor of a traditional computing device, such as a server computer, a desktop computer, or a laptop computer (referred to simply as a “computer”). Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

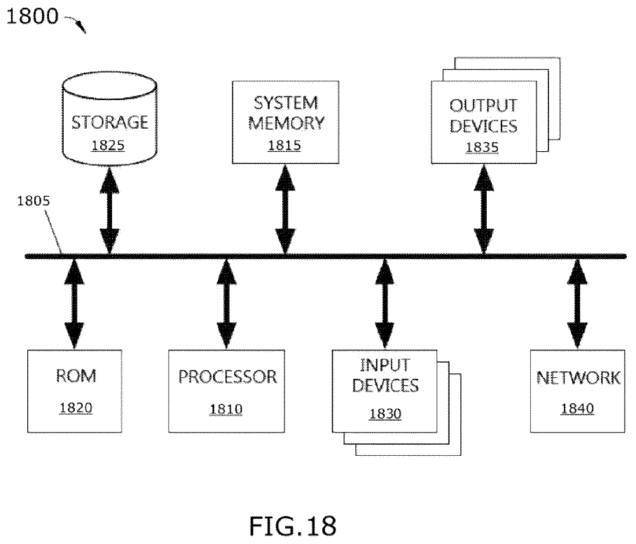

FIG. 18 conceptually illustrates an electronic system 1800 with which some embodiments of the invention are implemented. The electronic system 1800 may be a computer, mobile device, tablet, phone, PDA, or any other sort of electronic device. Such an electronic system includes various types of computer readable media and interfaces for various other types of computer readable media. Electronic system 1800 includes a bus 1805, processing unit(s) 1810, a system memory 1815, a read-only memory 1820, a permanent storage device 1825, input devices 1830, output devices 1835, and a network 1840.

The bus 1805 collectively represents all system, peripheral, and chipset buses that communicatively connect the numerous internal devices of the electronic system 1800. For instance, the bus 1805 communicatively connects the processing unit(s) 1810 with the read-only memory 1820, the system memory 1815, and the permanent storage device 1825.

From these various memory units, the processing unit(s) 1810 retrieves instructions to execute and data to process in order to execute the processes of the invention. The processing unit(s) may be a single processor or a multi-core processor in different embodiments.

The read-only-memory (ROM) 1820 stores static data and instructions that are needed by the processing unit(s) 1810 and other modules of the electronic system. The permanent storage device 1825, on the other hand, is a read-and-write memory device. This device is a non-volatile memory unit that stores instructions and data even when the electronic system 1800 is off Some embodiments of the invention use a mass-storage device (such as a magnetic or optical disk and its corresponding disk drive) as the permanent storage device 1825.

Other embodiments use a removable storage device (such as a floppy disk or a flash drive) as the permanent storage device 1825. Like the permanent storage device 1825, the system memory 1815 is a read-and-write memory device. However, unlike storage device 1825, the system memory 1815 is a volatile read-and-write memory, such as a random access memory. The system memory 1815 stores some of the instructions and data that the processor needs at runtime. In some embodiments, the invention's processes are stored in the system memory 1815, the permanent storage device 1825, and/or the read-only memory 1820. For example, the various memory units include instructions for processing appearance alterations of displayable characters in accordance with some embodiments. From these various memory units, the processing unit(s) 1810 retrieves instructions to execute and data to process in order to execute the processes of some embodiments.

The bus 1805 also connects to the input and output devices 1830 and 1835. The input devices enable the user to communicate information and select commands to the electronic system. The input devices 1830 include alphanumeric keyboards and pointing devices (also called “cursor control devices”). The output devices 1835 display images generated by the electronic system 1800. The output devices 1835 include printers and display devices, such as cathode ray tubes (CRT) or liquid crystal displays (LCD). Some embodiments include devices such as a touchscreen that functions as both input and output devices.

As shown in FIG. 18, bus 1805 also couples electronic system 1800 to a network 1840 through a network adapter (not shown). In this manner, the computer can be a part of a network of computers (such as a local area network (“LAN”), a wide area network (“WAN”), or an intranet), or a network of networks (such as the Internet). Any or all components of electronic system 1800 may be used in conjunction with the invention.

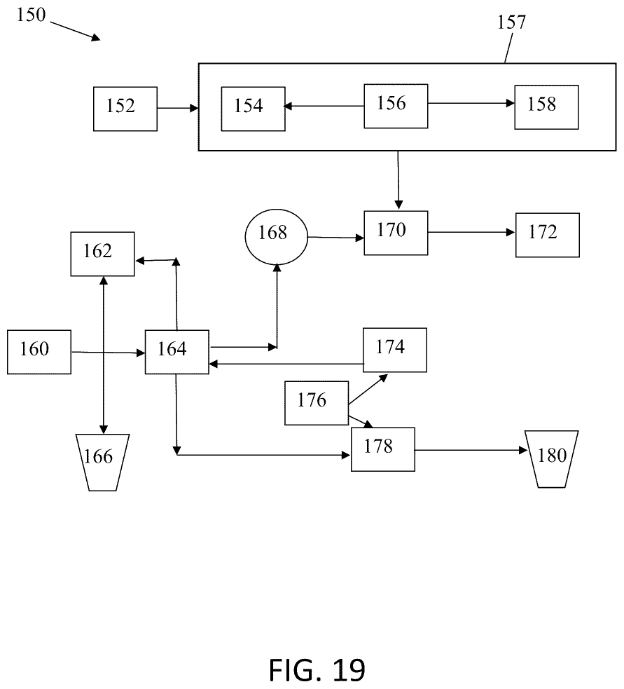

FIG. 19 shows a diagram of a system of services is provide 150 which uses cloud computing 152 for a CI/CD stack 157. In the CI/CD stack 157, cold pipeline 156 builds with module 158 and pulls changes with commit module 154. The CI/CD stack deploys a module 170 which updates a database 172. Module 170 receives the application microservice from a network load balancer 168 which is fed from an APA gateway 164. A client 160 authorizes use of the system through an authentication application 162 putting static web content in a data service 166. An exchange rate data service 178, which may be a fully managed service for delivering real-time streaming data to other services, is refreshed from data service 180. Records 176 are processed between a web service 174 and the exchange rate data service 178 and the web service 14 can relay the exchange rate through the API gateway 164.

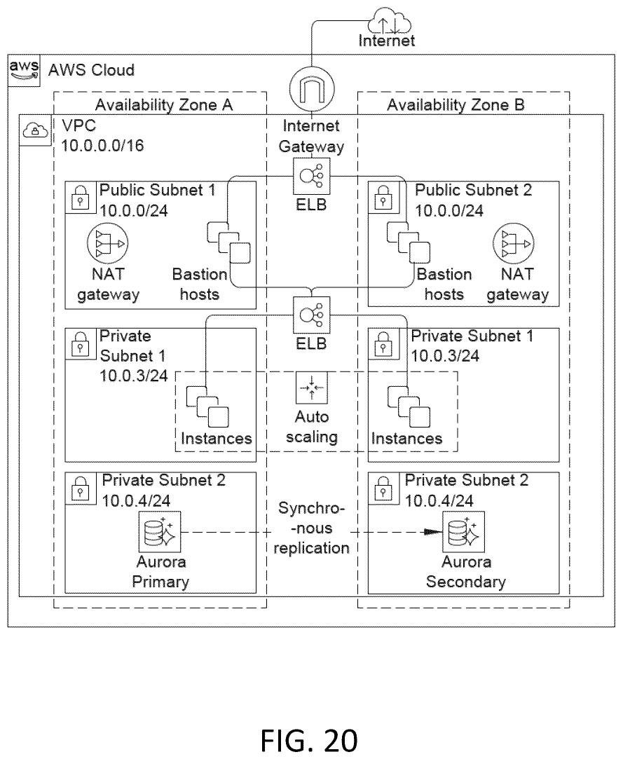

FIG. 20 shows a diagram of one embodiment of the invention. The infrastructure is hosted in AWS cloud or other cloud service. Internet traffic passes through Internet Gateway and is routed by elastic load balancer to either of the two private subnets based on the IP address of the user. Internet traffic either passed to subnet 1 or subnet 2. Both the sub nets have network interface and private subnets which secures SQL and APP servers in that region that host the application. There is a synchronization service always running between two subnets to sync data via SQL server replication.

One aspect of the present invention is directed to a computer readable medium including instructions which, when executed by a processor, cause the computer readable medium to carry out steps of performing a delivery process for requesting and receiving money. The delivery process includes a user accessing a login and signup screen 12 and the system creating a subscriber profile with a subscriber type 18. If the subscriber profile is not complete 20, sending at least one reminder until the subscriber completes the subscriber profile 16. If the subscriber type is a service provider 22, capturing the subscriber consent to execute a background check. If the background check is passed from checking agency 24, updating a status of subscriber profile with a background check status; and returning the user to the login and signup screen 26. If the background check is not passed from the checking agency, declining subscription to the user and send an email to the user 28. If the subscriber type is not a service provider and if the user intends to initiate a transaction 14 and if the user want to send money, the money sender subscriber initiate this transaction 30. The delivery process includes choosing a money receiver subscriber mapped to a money sender subscriber 54. If the money receiver subscriber is not found 56, creating a money receiver subscriber profile 58. The delivery process includes initiating a send money transaction 60 and depositing the money sent in a system administrator bank account 62. The delivery process includes the money sender and money receiver receiving a system generated transaction code 64 and performing a broadcast transaction 66. The delivery process includes the money receiver subscriber initiating a transaction 35, linking the money sender subscriber to the money receiver subscriber 36, initiating a request for a money transaction 38 and routing the money transaction to a designated money sender subscriber 40. The delivery process includes the money sender subscriber reviewing the transaction 42 and, if the money transfer is approved 44, process the send money transaction 46. If the money transfer is not approved, declining the money transaction 47 and switching the money transaction status to declined; 48 and skipping to the end program step 50. The delivery process includes broadcasting the transaction to service providers who covers the money receiver zip code 52 and, if the service provider accepts transaction 68 the service provider subscriber accepts the transaction 70, linking money transaction to service provider who accepted transaction and marking the transaction as reserved 72. The delivery process includes removing the money transaction from the broadcast 74, the service provider delivering money to money receiver 76, the service provider keying in transaction code shared by money receiver subscriber 78, a system administrator validating the transaction code 79 and, if the code is valid 80, transferring money to service provider account 92 and marking the transaction as completed 94 and ending program 96, and if the code is not valid, declining the transfer to service provider 82 and increment number of attempts by 1 [84], and if the number of attempts is less than 3 [86], then returning 90 to checking if the code is valid 80, and if the number of attempts is not less than 3, GOTO 88 Broadcast transaction to service providers who covers the money receiver zip code 68. The delivery process steps include ending the program.

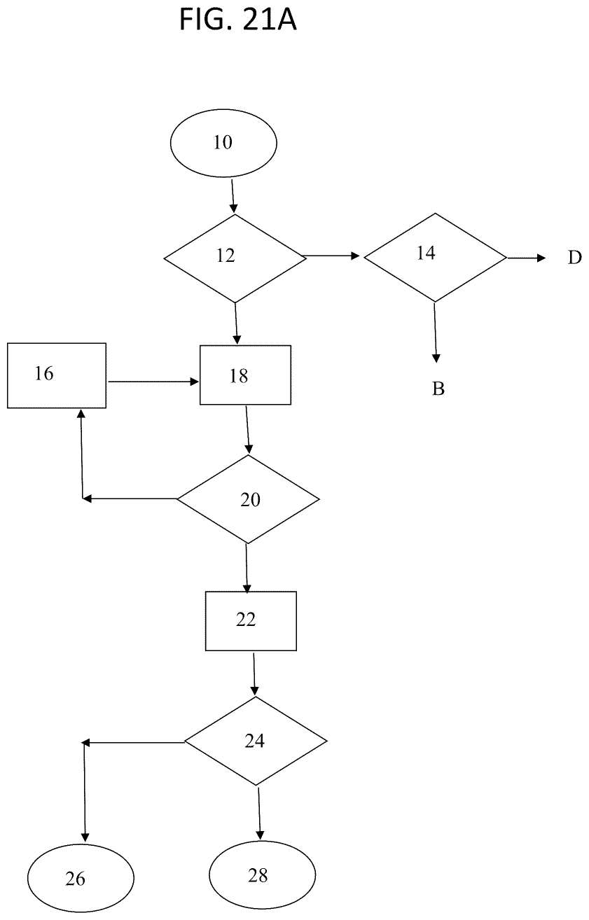

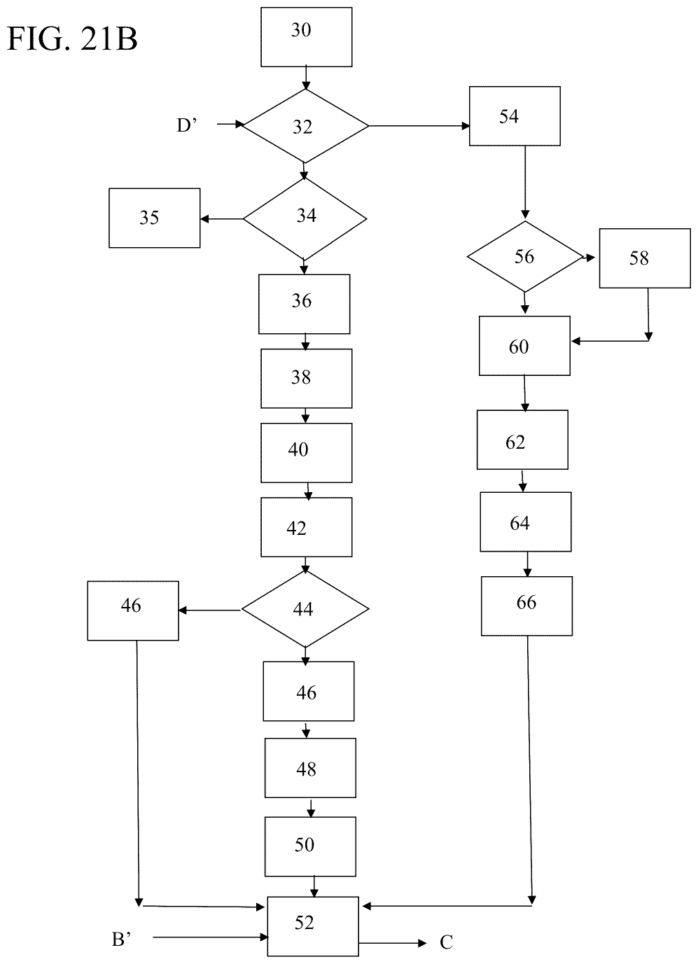

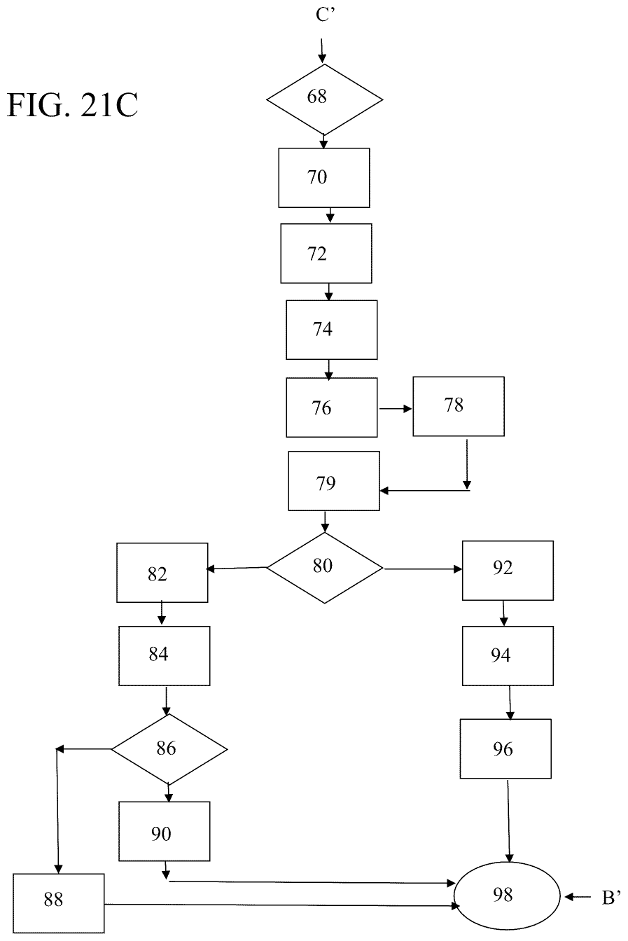

Another aspect of the present invention is directed to a computer readable medium comprising instructions which, when executed by a processor, cause the computer readable medium to carry out steps of a delivery process for requesting and receiving money. The steps as shown in the flowchart of FIGS. 21A-C begin with a user accessing a login and signup screen 12 and the system creating a subscriber profile with a subscriber type 18. If the subscriber profile is not complete 20, sending at least one reminder until the subscriber completes the subscriber profile 16. If the subscriber type is a service provider 22 the steps include capturing the subscriber consent to execute a background check. If the background check is passed from checking agency 24, a status of subscriber profile is updated with a background check status and returning the user to the login and signup screen 26. If the background check is not passed from the checking agency, the user subscription is declined and an email is sent to the user 28. If the subscriber type is not a service provider and if the user intends to initiate a transaction 14 and if the user want to send money, the money sender subscriber initiates the transaction 30. The steps include choosing a money receiver subscriber mapped to a money sender subscriber 54. If the money receiver subscriber is not found 56, creating a money receiver subscriber profile 58. The steps include initiating a send money transaction 60 and depositing the money sent in a system administrator bank account 62. The steps include the money sender and money receiver receiving a system generated transaction code 64, and the instructions skip to the step of broadcasting the transaction to service providers who covers the money receiver zip code 66. If the money receiver subscriber is found, the money receiver subscriber initiates a transaction 35. The instructions include linking the money sender subscriber to the money receiver subscriber 36, initiating a request for a money transaction 38 and routing the money transaction to a designated money sender subscriber 40. The money sender subscriber reviews the transaction 42, and if the money transfer is approved 44, send money transaction occurs 46 and instructions skip to the step of broadcasting the transaction to service providers who covers the money receiver zip code. If the money transfer is not approved, the steps include declining the money transaction 47 and switching the money transaction status to declined and skipping to the end program step 50. The steps include broadcasting the transaction to service providers who covers the money receiver zip code 52. If the service provider accepts transaction 68, the service provider subscriber accepts the transaction 70, linking money transaction to service provider who accepted transaction and marking the transaction as reserved 72. The steps include removing the money transaction from the broadcast 74, the service provider delivering money to money receiver 76, the service provider keying in transaction code shared by money receiver subscriber 78, a system administrator validating the transaction code 79. If the code is valid 80, the instructions include transferring money to service provider account 92 and marking the transaction as completed 94 and ending program 96. If the code is not valid, declining the transfer to service provider 82 and increment number of attempts by 1. If the number of attempts is less than 3 [86], then returning 90 to checking if the code is valid 80. If the number of attempts is not less than 3, the instructions skip to the step of broadcasting the transaction to service providers who covers the money receiver zip code to service providers who covers the money receiver zip code 68. The program instructions end.

In an example of a process for monetary delivery, the following are the instructions lines which follow the flowchart provided in FIGS. 21A, 21B, and 21C:

Start;
Login/Signup: 10
If (Not subscribed in the system ?) 12 {
Create subscriber profile with subscriber type; 18
while(!Subscriber profile initiated not completed?) 20
{
Send Reminders to subscriber to complete his profile; 16
}
if(Subscriber type = Service Provider ?) 22
{
Capture his consent to execute background check;
if(Check passed from agency ?) 24
{
Update status of subscriber profile with background check status
GOTO Login/Signup; 26
}
else
{
Decline subscription to subscriber and send email; 28
}
}
}
else
{
if(Intend to Initiate Transaction ?) 14
{
if(Send Money ?) 32 //Money sender subscriber initiate this transaction 30
{
Choose money receiver subscriber mapped to money sender subscriber; 54
if(Money Receiver subscriber not found ?) 56
{
Create Money Receiver Subscriber profile; 58
}
SendMoneyTransaction:
Initiate Send Money Transaction; 60
Money sent will be deposited in System Administrator bank account; 62
Money Sender and money receiver will receive system generated transaction code; 64
GOTO BroadcastTransaction; 66
}
else if(Receive Money ?) 34 //Money receiver subscriber can initiate this transaction 35
{
Choose money sender subscriber linked to money receiver subscriber; 36
Initiate Request Money Transaction; 38
Money Transaction will be routed to designated money sender subscriber; 40
Money Sender subscriber will review the transaction; 42
if(Approve Money Transfer ?) 44
{
GOTO SendMoneyTransaction; 46
}
else
{
Decline money Transaction; 47
Switch Money Transaction status to declined; 48
GOTO End; 50
}
}
BroadcastTransaction:
Broadcast transacton to service providers who covers the money receiver zip code; 52
if(Service provider accept transaction?) 68
{
Service Provider subscriber will accept the transaction; 70
Money Transaction will be linked to service provider who accepted transaction and will
mark transaction as reserved; 72
Money Transaction will be removed from the broadcast; 74
Service Provider will deliver money to money receiver; 76
ValidateTransactionCode:
Service Provider keys in transaction code shared by money receiver subscriber; 78
System admin validates transaction code; 79
if(Code Valid ?) 80
{
Transfer money to service provider account; 92
Mark transaction as completed; 94
GOTO End; 96
}
else
{
Decline the transfer to service provider; 82
Increment attempts by 1; 84
if(Attempt < 3) 86
{
GOTO ValidateTransactionCode; 90
}
else
{
GOTO BroadCastTransaction; 88
}
}
}
}
End ! 98

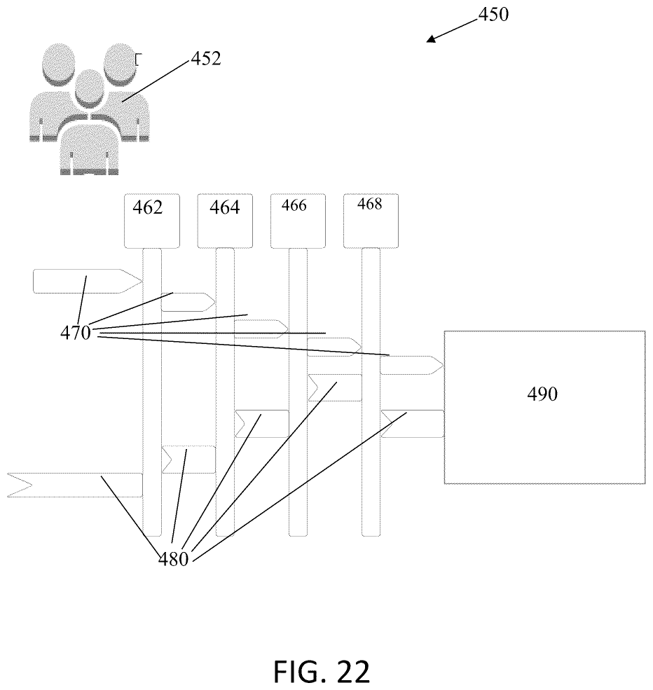

FIG. 22 shows a diagram of a system module 450 having users 452 perform a specific request 470. The request is repeated at each authentication layer and the request travels through layers of authentication requests to arrive at a transaction being performed and recorded 490. Each layer is marked as having a successful authentication 480. The layers may include any combination of User Interface 462, API Management system 464, API 466 and Data layer 468. The specific request may include but are not limited to:
add money transaction type;
add currency request;
exchange rate request;
remove money transaction request;
retrieve all currencies; and
update money transaction request.

These functions described above can be implemented m digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include e electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, disc media (CDs, DVDs, Blu-Ray® discs, ultra density optical discs, etc.), flash memory (e.g., SD cards, mini-SD cards, micro-SD cards, etc.), magnetic and/or solid state hard drives, and/or any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A computer readable medium comprising instructions which, when executed by a processor, cause the computer readable medium to carry out steps of a delivery process for requesting and receiving money, the steps comprising:
a user accessing a login and signup screen and the system creating a subscriber profile with a subscriber type and if the subscriber profile is not complete, sending at least one reminder until the subscriber completes the subscriber profile;
if the subscriber type is a service provider, capturing the subscriber consent to execute a background check;
if the background check is passed from checking agency, updating a status of subscriber profile with a background check status; and returning the user to the login and signup screen;
and if the background check is not passed from the checking agency, declining subscription to the user and send an email to the user;
if the subscriber type is not a service provider and if the user intends to initiate a transaction and if the user want to send money, the money sender subscriber initiating this transaction;
choosing a money receiver subscriber mapped to a money sender subscriber;
if the money receiver subscriber is not found, creating a money receiver subscriber profile, initiating a send money transaction, depositing the money sent in a system administrator bank account, the money sender and money receiver receiving a system generated transaction code, and skipping to the step of broadcasting the transaction to service providers who covers the money receiver zip code;
if the money receiver subscriber is found the money receiver subscriber initiating a transaction;
linking the money sender subscriber to the money receiver subscriber;
initiating a request for a money transaction; and routing the money transaction to a designated money sender subscriber;
the money sender subscriber reviewing the transaction;
if the money transfer is approved, send money transaction occurs and instructions skip to the step of broadcasting the transaction to service providers who covers the money receiver zip code;
if the money transfer is not approved, declining the money transaction; and switching the money transaction status to declined; and skipping to the end program step;
broadcasting the transaction to service providers who covers the money receiver zip code;
if the service provider accepts transaction, the service provider subscriber accepts the transaction, linking money transaction to service provider who accepted transaction and marking the transaction as reserved;
removing the money transaction from the broadcast;
the service provider delivering money to money receiver;
the service provider keying in transaction code shared by money receiver subscriber;
a system administrator validating the transaction code;
if the code is valid, transferring money to service provider account and marking the transaction as completed and ending program;
if the code is not valid, declining the transfer to service provider; and increment number of attempts by 1;
if the number of attempts is less than 3, then returning to checking if the code is valid;
if the number of attempts is not less than 3, skipping to the step of broadcasting the transaction to service providers who covers the money receiver zip code to service providers who covers the money receiver zip code; and
ending the program.
